(19) United States
(12) Patent Application Publication
(10) Pub. No.: US 2007/0046040 A1
(43) Pub. Date: Mar. 1, 2007

(54) Electronic lock

(76) Inventor: Chen-Fei Chang, Taipei (TW)

Correspondence Address: RABIN & Berdo, PC, 1101 14TH STREET, NW, SUITE 500, WASHINGTON, DC, 20005, US

(21) Appl. No.: 11/212,761

(22) Filed: Aug. 29, 2005

(51) Int. Cl. E05B 15/02

(52) U.S. Cl. 292/341.16

(57) ABSTRACT

An electronic lock includes a housing, a solenoid, a lock bar, a solenoid cover, and a faceplate. The solenoid is received in and mounted to the housing and the solenoid has a retractable rod being spring biased to a first position when the solenoid is not energized and magnetically moved to a second position when the solenoid is energized. The lock bar is pivotably mounted to a pivot pin, and the pivot pin is mounted with a spring member and fixed to two ends of the housing. The solenoid cover is covered on the solenoid and the faceplate is mounted to the housing. The solenoid cover and the faceplate define a latch bolt cavity. When the solenoid is energized, the retractable rod is withdrawn to the second position, so that the lock bar can be transversely rotated, thereby detaching from a latch bolt and allowing a door to be opened.

### BACKGROUND OF THE INVENTION

1. Field of the Invention

The present invention relates generally to electronic locks, and in particular to an electronic lock capable of providing different effects by means of changing mount location of a solenoid in the electronic lock during a power-on and a power failure.

2. The Prior Arts

In order to ensure security of people's lives and properties, a conventional mechanical lock integrated with an electronic device becomes an electronic lock for guarding for example office buildings, which can be disabled only by a decoding measure.

The conventional electronic lock mainly comprises a lock body and a sensor, in which the lock body is provided with a housing, a solenoid and a lock bar movable in transverse direction; the sensor is provided with a keyboard having a plurality of keys for setting a code or decoding, and a control circuit for controlling the operation of the electronic lock according to signals received from the sensor.

When the electronic lock is desired to unlock, usually for example a coded card is taken to close the sensor to sense and check whether its code is correct or not. If the code is correct, a retractable rod of the solenoid is withdrawn by energizing the solenoid and under the control of the control circuit, so that the lock bar can be transversely rotated and then allow the door to be opened.

By energizing the solenoid, it is very convenient for such conventional electronic locks to withdraw the retractable rod of the solenoid to have the lock bar rotated and thus allow the door to be opened. However, when power off, the lock fails to be unlocked; hence, some makeup measures for unlocking the electronic lock must be taken into consideration.

### SUMMARY OF THE INVENTION

The primary objective of the present invention is to provide an electronic lock, which is able to provide different effects by means of changing mount location of a solenoid in the electronic lock during a power-on and a power failure.

In order to attain the objective mentioned above, an electronic lock in accordance with the present invention comprises a housing, a solenoid, a lock bar, a solenoid cover, and a faceplate. The solenoid is mounted on a frame having through holes on a base thereof, which is received in and mounted to the housing, and the solenoid has a retractable rod being spring biased to a first position when the solenoid is not energized and magnetically moved to a second position when the solenoid is energized. The lock bar is pivotably mounted to a pivot pin, and the pivot pin is mounted with a spring member and fixed to two ends of the housing. The solenoid cover is covered on the solenoid and fixed to a sidewall of the housing. The faceplate is mounted to the housing, and the faceplate and the solenoid cover defines a latch bolt cavity. The housing has slots on a base thereof corresponding to the through holes of the frame for securing the frame to the housing.

The present invention has thus the following merits:

1. Thanks to the housing having slots, the solenoid can be movably secured to the lower parts of the slots of the housing. When the solenoid is energized, a first end of the retractable rod of the solenoid is withdrawn to the second position, so that the lock bar can be transversely rotated, thereby detaching from a latch bolt and allowing a door to be opened.

2. Thanks to the housing having slots, the solenoid can be movably secured to the upper parts of the slots of the housing. When there is a power failure and no voltage is available to energize the solenoid, the first end of the retractable rod of the solenoid is extended downward while the second end of the retractable rod is withdrawn, so that the lock bar can be transversely rotated, thereby detaching from the latch bolt and allowing the door to be opened.

For more detailed information regarding advantages or features of the present invention, at least one example of preferred embodiment will be described below with reference to the annexed drawings.

### BRIEF DESCRIPTION OF THE DRAWINGS

The related drawings in connection with the detailed description of the present invention to be made later are described briefly as follows, wherein:

FIG. 1 is an exploded perspective view of an electronic lock in accordance with the present invention;

FIG. 2 is a perspective view of the electronic lock of the present invention with a solenoid cover not mounted therein;

FIG. 3 is a sectional view showing that the electronic lock of the present invention is in a lock position;

FIG. 4 is an expanded sectional view taken along line 4-4 in FIG. 3;

FIG. 5 is a sectional view showing that the electronic lock of the present invention is in an unlock position;

FIG. 6 is an expanded sectional view taken along line 6-6 in FIG. 5;

FIG. 7 is a sectional view showing that an electronic lock in accordance with another assembly of the present invention is in an unlock position;

FIG. 8 is an expanded sectional view taken along line 8-8 in FIG. 7;

FIG. 9 is a sectional view showing that the electronic lock of another assembly of the present invention is in a lock position; and

FIG. 10 is an expanded sectional view taken along line 10-10 in FIG. 9.

### DETAILED DESCRIPTION OF THE PREFERRED EMBODIMENT

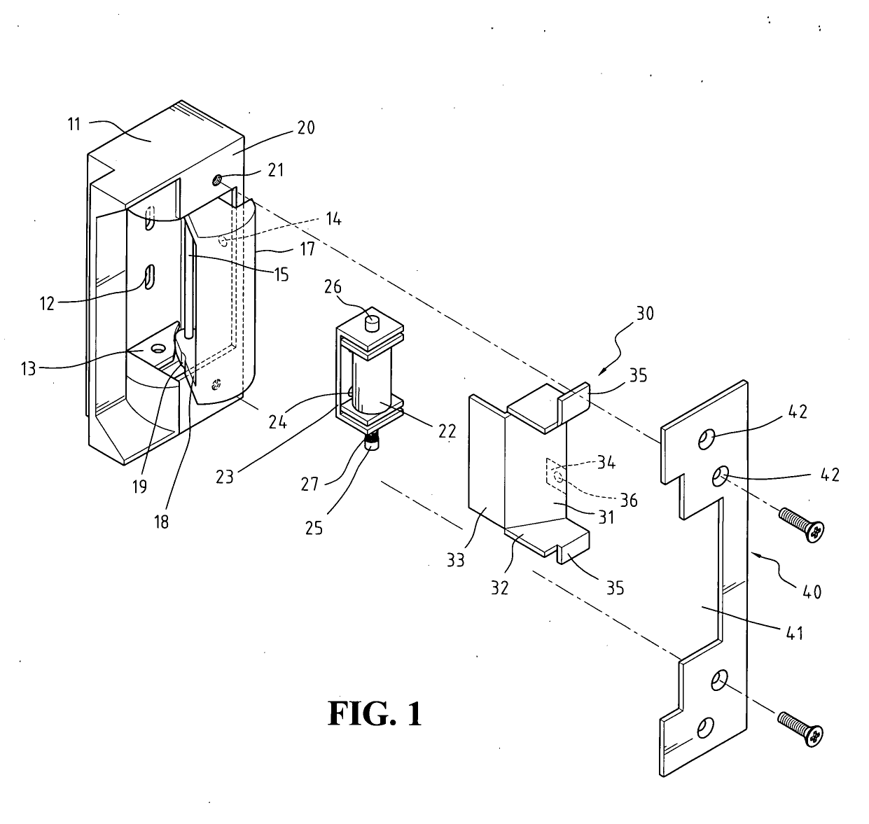

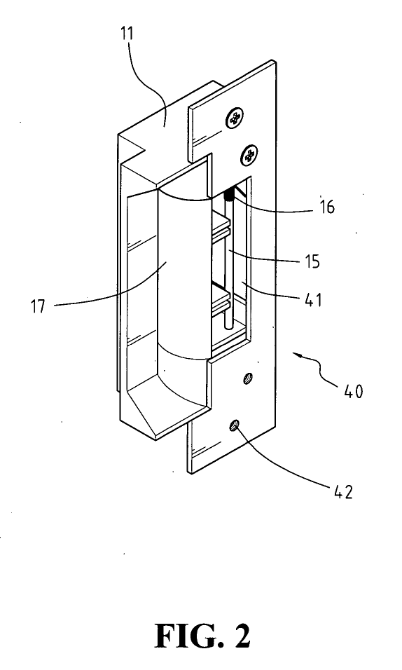

Referring to FIGS. 1-3, an electronic lock constructed in accordance with the present invention comprises a housing 11, a lock bar 17, a solenoid 22, a solenoid cover 30, and a faceplate 40.

The housing 11 is provided with two slots 12 and two brackets 13 on a base and a through hole 14 on a side face thereof. A torsion spring 16 is mounted to a pivot pin 15, and the pivot pin 15 is pivotably connected through two spaced laterally extending arms 18 extending from the lock bar 17 and then fixed to two ends of the housing 11. Each extending arm 18 has a notch 19 at a side thereof. The open side of the housing 11 forms two wing portions 20 at its top and bottom ends, each wing portion 20 having a screw hole 21 thereon. The lock bar 17 is received in the housing 11 and between the two wing portions 20.

The solenoid 22 is mounted to a frame 23 having two through holes 24 on a base thereof. The solenoid 22 has a retractable rod having a first end 25 and a second end 26, which are penetrably disposed in a hole of two end faces of the frame 23, respectively. A spring 27 is mounted to a neck portion of the first end 25 of the retractable rod. The retractable rod is spring biased to a first position when the solenoid is not energized and magnetically moved to a second position when the solenoid is energized.

The solenoid cover 30 completes the enclosure of the solenoid 22 and has a sloping face 31, two extending faces 32 forwardly extending from the top and bottom ends of the sloping face 31, a stabilizing tab 36 rearwardly extending from a side edge of the sloping face 31, and a fastener tab 34 rearwardly extending from the other side edge of the sloping face 31 and having a through hole 36 corresponding to the through hole 14 of the housing 11. An extending tab 35 perpendicularly extends from each extending face 32.

The faceplate 40 has a concave part 41 at its central portion and two through holes 42 formed at the top and bottom ends thereof, respectively and oppositely. The faceplate 40 provides for an attractive cover for the internal components of the electronic lock and a fixation to a door. After assembled, the solenoid cover 30 and the faceplate 40 define a latch bolt cavity.

Also referring to FIGS. 1-3, the assembly of the electronic lock of the present invention proceeds as follows. The frame 23 is first placed in and fixed to the housing 11 in a manner that the through holes 24 in the base of the frame 23 are aligned with lower parts of the slots 12 of the housing 11 and fixed thereto with bolts. At this time, the first end 25 of the retractable rod of the solenoid 22 is penetrated through a hole of the lower bracket 13 to bias against the notch 19 of the extending arm 18 of the lock bar 17, while the second end 26 of the retractable rod is aligned with a hole of the upper bracket 13. Subsequently, the solenoid cover 30 is covered on the solenoid 22 and fastened to the housing 11 by a screw passing through the through hole 36 of the solenoid cover 30 and the through hole 14 of the housing 11 and fixing them together; then, the faceplate 40 is mounted to the housing 11 by screws passing through the through holes 42 of the faceplate 40 and the screw holes 21 of the housing 11 and fixing them together. Finally, the solenoid 22 is electrically connected to a power source and a sensor (not shown) to complete the assembly of the present invention. In this embodiment, when the solenoid 22 is not energized, the lock bar 17 is positioned at a lock position.

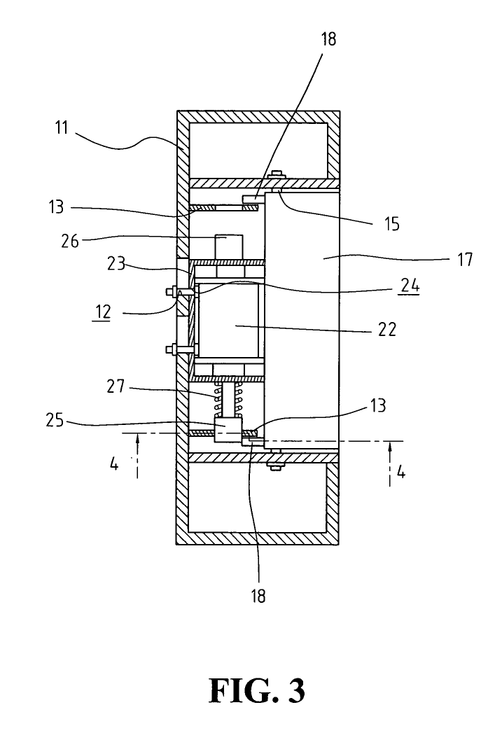

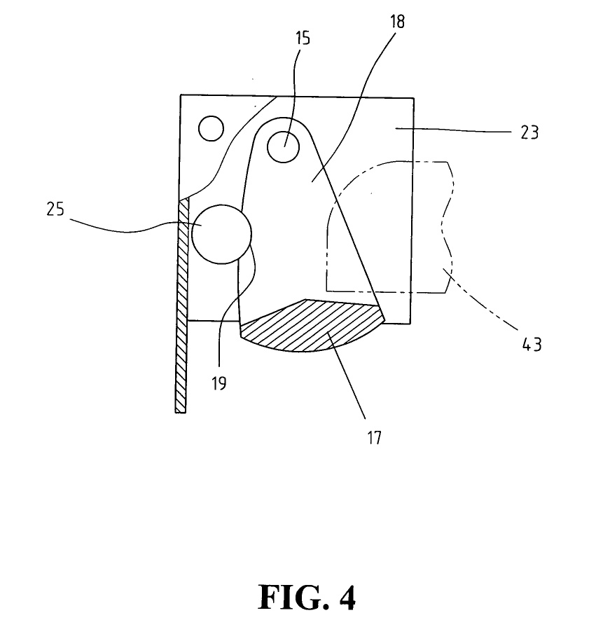

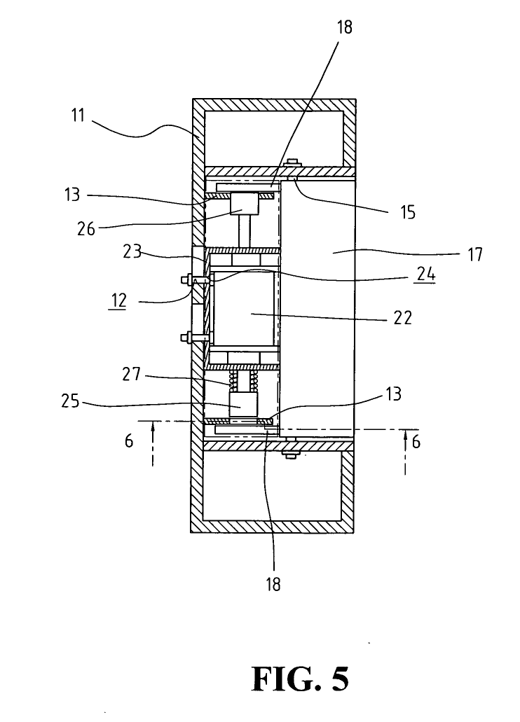

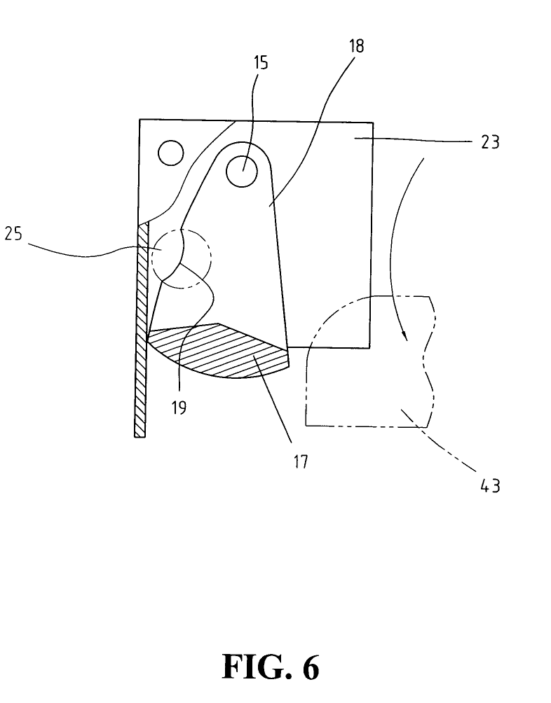

Referring to FIGS. 3-6, in operation of the electronic lock of the present invention, the sensor detects whether a code recorded in a card or substitute things is correct or not. If the code is correct, by energizing the solenoid 22 and under the control of a control circuit (not shown), the first end 25 of the retractable rod of the solenoid 22 is withdrawn from the through hole of the bottom bracket 13 and meanwhile, the second end 26 of the retractable rod is extended upward but not penetrate through the hole of the upper bracket 13, so that the lock bar 17 can be transversely rotated and detached from a latch bolt 43 to allow the door to be opened. On the contrary, when the solenoid 22 is not energized, the torsion spring 16 mounted to the pivot pin 15 will push the lock bar 17 back to the lock position to lock the latch bolt 43 and meanwhile, the spring 27 mounted at the neck of the first end 25 of the retractable rod of the solenoid 22 pushes the first end 25 and the second end 26 of the retractable rod downward to their original positions to stop the lock bar 17 being unlocked to complete an operation cycle. At this time, the lock bar 17 is back to its original lock position.

Referring to FIGS. 1-2 and 7, a second assembly of the electronic lock of the present invention proceeds as follows. The frame 23 is first placed in and fixed to the housing 11 in a manner that the through holes 24 in the base of the frame 23 are aligned with upper parts of the slots 12 of the housing 11 and fixed thereto with bolts. At this time, the first end 25 and the second end 26 of the retractable rod are aligned with the through holes of the two brackets 13, respectively, but not penetrate through the through holes of the two brackets 13. Subsequently, the solenoid cover 30 is covered on the solenoid 22 and fastened to the housing 11 by a screw passing through the through hole 36 of the solenoid cover 30 and the through hole 14 of the housing 11 and fixing them together; then, the faceplate 40 is mounted to the housing 11 by screws passing through the through holes 42 of the faceplate 40 and the screw holes 21 of the housing 11 and fixing them together. Finally, the solenoid 22 is electrically connected to a power source and a sensor (not shown) to complete the second assembly of the present invention. In this embodiment, when the solenoid is not energized, the lock bar 17 is positioned at an unlock position.

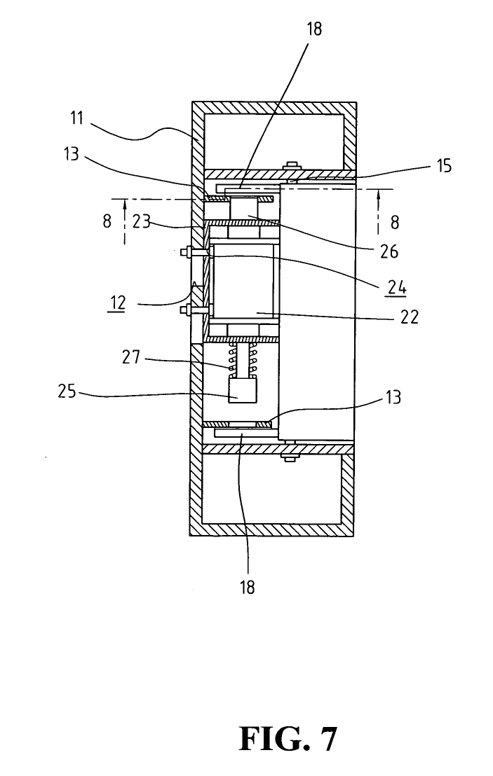

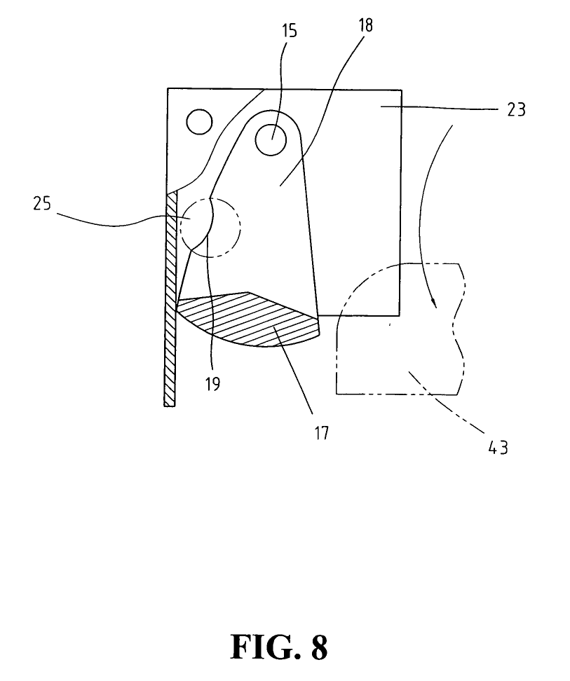

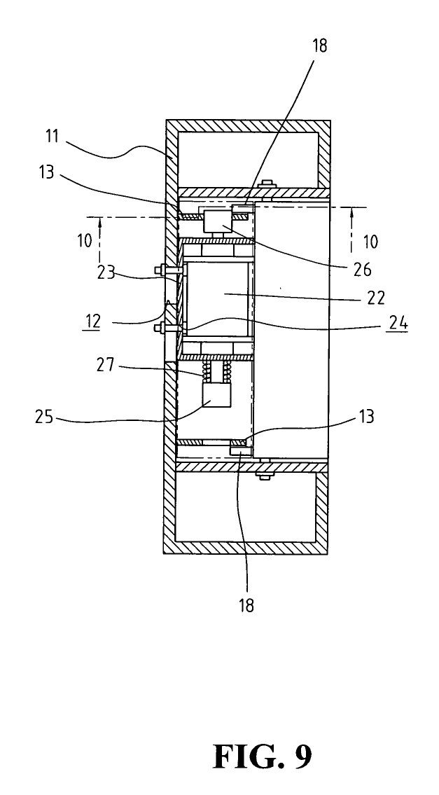

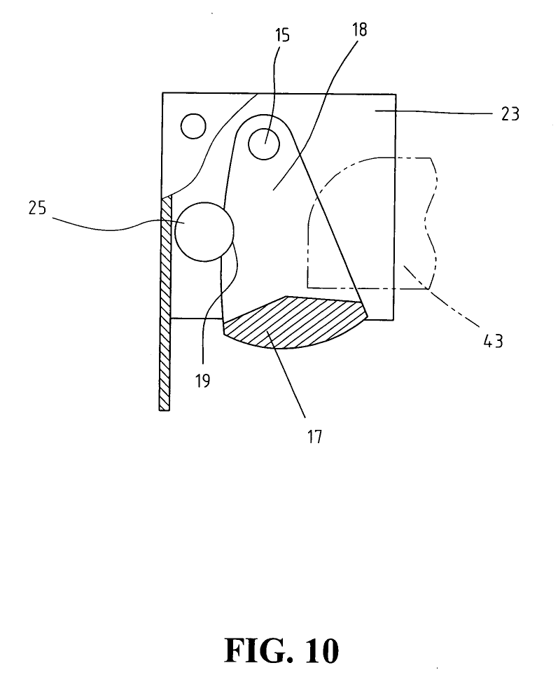

Moreover, as illustrated in FIGS. 7-10, in the second assembly of the electronic lock of the present invention, when there is a power failure and no voltage is available to energize the solenoid 22, the first end 25 of the retractable rod of the solenoid 22 is extended downward while the second end 26 of the retractable rod 26 is withdrawn, so that the lock bar 17 can be transversely rotated to detach from the latch bolt 43. On the contrary, when the power is restored and energized on the solenoid 22, the second end 26 of the retractable rod is extended upward and penetrated through the hole of the upper bracket 13 to bear against the notch 19 of the extending arm 18 to stop the lock bar 17 being rotated. At this time, the lock bar 17 is positioned at the lock position.

In the above described, at least one preferred embodiment has been described in detail with reference to the drawings annexed, and it is apparent that numerous changes or modifications may be made without departing from the true spirit and scope thereof, as set forth in the claims below.

1. An electronic lock, comprising
a housing having slots and two opposing brackets, each bracket having a hole;
a frame fixed to the housing and being disposed between the brackets, the frame having through holes on a base thereof, each through hole being in registration with a respective slot;
a solenoid mounted on the frame, the solenoid having a retractable rod, the retractable rod being spring biased to a first position when the solenoid is not energized and being magnetically moved to a second position when the solenoid is energized;
a lock bar having two spaced laterally extending arms, the lock bar being pivotably mounted to the housing via a pivot pin
a solenoid cover covering the solenoid and being fixed to the housing; and
a faceplate mounted to the housing, the faceplate and the solenoid cover being assembled together in a way that the faceplate and the solenoid cover define a cavity for accommodating a latch bolt;
the slots being shaped so that
(a) when the through holes of the frame are aligned with first parts of the slots and when the retractable rod is spring biased to the first position, one end of the retractable rod protrudes from the hole of a first one of the two brackets thereby retaining the lock bar at a lock position by interfering with the arm of the lock bar, and when the retractable rod is in the second position, no end of the retractable rod protrudes from any hole of the two brackets thereby placing the lock bar at a non-locking position and
(b) when the through holes of the frame are aligned with second parts of the slots and when the retractable rod is spring biased to the first position, no end of the retractable rod protrudes from any hole of the two brackets thereby placing the lock bar at a non-locking position, and when the retractable rod is in the second position, one end of the retractable rod protrudes from the hole of a second one of the two brackets thereby retaining the lock bar at a lock position by interfering with the arm of the lock bar.

2. The electronic lock as claimed in claim 1, wherein the first parts of the slots are lower parts of the slots.

3. The electronic lock as claimed in claim 1, wherein the second parts of the slots are upper parts of the slots.

4. The electronic lock as claimed in claim 1, wherein the frame is fixed to the housing with bolts passing through the slots of the housing and the through holes of the frame.

5. The electronic lock as claimed in claim 1, wherein each extending arm of the lock bar has a notch in a side thereof.

6. The electronic lock as claimed in claim 1, wherein the pivot pin is mounted with a spring member.

7. The electronic lock as claimed in claim 1, wherein the pivot pin is fixed to two ends of the housing.

8. The electronic lock as claimed in claim 1, wherein the solenoid cover is fixed to a sidewall of the housing.

9. An electronic lock, comprising:
a housing having slots and two opposing brackets, each bracket having a hole;
a frame fixed to the housing and being disposed between the brackets, the frame having through holes on a base thereof, each through hole being in registration with a respective slot;
a solenoid mounted on the frame, the solenoid having a retractable rod, the retractable rod being spring biased to a first position when the solenoid is not energized and being magnetically moved to a second position when the solenoid is energized; and
a lock bar having two spaced, laterally extending arms, the lock bar being pivotably mounted to the housing via a pivot pin;
the slots being shaped so that the slots are capable of changing mount location of the solenoid (a) from a first mount location where the lock bar is retained at a lock position by the retractable rod which interferes with the arm of the lock bar when the retractable rod is in the first position while the lock bar is in a non-locking position when the retractable rod is moved to the second position (b) to a second mount location where the lock bar is in a non-locking position when the retractable rod is in the first position while the lock bar is retained at a lock position by the retractable rod which interferes with the arm of the lock bar when the retractable rod is moved to the second position.

10. The electronic lock as claimed in claim 9, wherein, when the solenoid is located at the first mount location, the through holes of the frame are aligned with lower parts of the slots.

11. The electronic lock as claimed in claim 9, wherein, when the solenoid is located at the second mount location, the through holes of the frame are aligned with upper parts of the slots.

12. The electronic lock as claimed in claim 9, wherein the frame is fixed to the housing with bolts passing through the slots of the housing and the through holes of the frame.
